(19) United States
(12) Patent Application Publication
(10) Pub. No.: US 2015/0193395 A1
(43) Pub. Date: Jul. 9, 2015

(54) PREDICTIVE LINK PRE-LOADING

(71) Applicants: Alexander Nicolaou, Waterloo (CA); Wallace James MacLean, Hawkestone (CA)

(72) Inventors: Alexander Nicolaou, Waterloo (CA); Wallace James MacLean, Hawkestone (CA)

(73) Assignee: GOOGLE INC., Mountain View, CA (US)

(21) Appl. No.: 13/561,492

(22) Filed: Jul. 30, 2012

(51) Int. Cl. G06F 17/22; G06N 7/00; G06N 99/00; G06F 17/30

(52) U.S. Cl. CPC G06F 17/2247; G06F 17/2235; G06F 17/3053; G06N 7/005; G06N 99/005

(57) ABSTRACT

The present technology provides techniques for predicting links on a web page and preloading content associated with predicted links. A method in accordance with the techniques includes retrieving a user-desired web page. The user desired web page includes one or more links. A predicted link is identified in the one or more links on the web page. The predicted link is identified based on a likelihood that the link will be selected by a user of the web browser. The likelihood is determined using a proximity metric that is one of a Euclidean distance from a current position of a touch gesture or mouse position to the link, or a constant velocity approximation of gesture trajectory. A popularity score associated with the one or more links on the user-desired webpage is identified and a web page associated with the predicted link is preloaded into a memory of the web browser.

### BACKGROUND

1. Field

The present disclosure relates to web browsers.

2. Background

The Internet provides access to a wide range of resources. For example, web pages for particular subjects are accessible over the Internet. These resources may be retrieved and viewed by users by typing in an identifier (e.g., a URL), or by clicking a link for the location of the resource. Once a user clicks a link, a web browser may begin retrieving the resource.

### BRIEF SUMMARY

Embodiments disclosed herein include methods, systems, and computer readable media for preloading links that are predicted to be clicked by a user. A method in accordance with an embodiment includes retrieving a user-desired web page by a web browser. The user-desired web page contains one or more links. A predicted link in the one or more links on the user-desired web page is identified. The predicted link is identified based on a likelihood that the link will be selected by a user of the web browser. The likelihood is determined using a proximity metric to determine the predicted link in the one or more links on the user-desired webpage that is likely to be selected by the user of the web browser. In that regard, the proximity metric is one of a Euclidean distance from a current position of a touch gesture or mouse position to the link, or a constant velocity approximation of gesture trajectory. A popularity score associated with the one or more links on the user-desired webpage is identified and a web page associated with the predicted link is preloaded into a memory of the web browser.

A system, in accordance with an embodiment, may include one or more computers and one or more storage devices that store instructions. The instructions are operable, when executed by the one or more computers, to cause the one or more computers to perform operations including retrieving a user-desired web page by a web browser. The user-desired web page contains one or more links. The instructions further cause the one or more computers to identify a predicted link in the one or more links on the user-desired web page. The predicted link is identified based on a likelihood that the link will be selected by a user of the web browser. The likelihood is determined using a proximity metric to determine the predicted link in the one or more links on the user-desired webpage that is likely to be selected by the user of the web browser. In that regard, the proximity metric is one of a Euclidean distance from a current position of a touch gesture or mouse position to the link, or a constant velocity approximation of gesture trajectory. The instructions further cause the one or more computers to identify a popularity score associated with the one or more links on the user-desired webpage and preload a web page associated with the predicted link into a memory of the web browser.

In accordance with an embodiment, a non-transitory computer-readable medium storing software may be provided. The non-transitory computer-readable medium includes instructions executable by one or more computers which, upon such execution, cause the one or more computers to perform operations including retrieving a user-desired web page by a web browser. The user-desired web page contains one or more links. The operations further include identifying a predicted link in the one or more links on the user-desired web page. The predicted link is based on a likelihood that the link will be selected by a user of the web browser. The likelihood is determined using a proximity metric to determine the predicted link in the one or more links on the user-desired webpage that is likely to be selected by the user of the web browser. In that regard, the proximity metric is one of a Euclidean distance from a current position of a touch gesture or mouse position to the link, or a constant velocity approximation of gesture trajectory. The operations further includes identifying a popularity score associated with the one or more links on the user-desired webpage and preloading a web page associated with the predicted link into a memory of the web browser.

In accordance with a further embodiment, a system may include a processor and a memory. The system may also include a web browser, configured to retrieve a user-desired web page. The user-desired web page contains one or more links. The web browser may further be configured to identify a predicted link in the one or more links on the user-desired web page, based on a likelihood that the link will be selected by a user of the web browser. The likelihood is determined using a proximity metric to determine the predicted link in the one or more links on the user-desired webpage that is likely to be selected by the user of the web browser. In that regard, the proximity metric is one of a Euclidean distance from a current position of a touch gesture or mouse position to the link, or a constant velocity approximation of gesture trajectory. The web browser is further configured to identify a popularity score associated with the one or more links on the user-desired webpage and preload a web page associated with the predicted link into the memory of the system.

Further embodiments, features, and advantages of the invention, as well as the structure and operation of the various embodiments of the invention are described in detail below with reference to accompanying drawings.

### BRIEF DESCRIPTION OF THE DRAWINGS/FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIG. 1A is an example scenario of identifying a predicted link, in accordance with an embodiment.

FIG. 1B is a further example scenario of identifying a predicted link, in accordance with an embodiment.

FIG. 2 is a diagram of a system in accordance with an embodiment.

FIG. 3 is a flow diagram of a method in accordance with an embodiment.

FIG. 4 is a diagram of a system that may be used to implement embodiments.

### DETAILED DESCRIPTION

While the present invention is described herein with reference to the illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Nearly all web pages available on the Internet contain one or more links to other web pages. For example, a restaurant web site may include links to web pages containing the restaurant's menu, reservation information, contact information, and other information.

A user browsing the restaurant web site may select any of the links to browse the desired information. On a desktop or laptop computer, the user may select a desired link by moving her mouse pointer to the link and clicking her mouse on the link. On a touch-sensitive device, such as a smartphone or tablet computer, the user may user a finger to scroll or navigate the web page, move her finger to a desired link, and touch the screen where the link is displayed.

Once the user has selected the desired link, the web browser may begin the process of retrieving a web page associated with the link. For example, the web browser may convert the domain name (i.e. www.example.com) associated with the link to an Internet Protocol (IP) address (i.e. 192.0.43.10) by performing a domain name system (DNS) lookup. The web browser may then retrieve or download the Hypertext Markup Language (HTML) content of the web page associated with the link, and identify images and other multimedia content to be retrieved or downloaded.

The speed at which a web browser retrieves and renders content greatly affects user experience. Generally, the faster a web browser can retrieve and render content, the better the user experience. Users desire minimal delay from the time that a link is selected to when a web page associated with the link is available for view. To reduce the time necessary for retrieving and rendering content, web browsers may preload content of web pages associated with links on a web page. A web browser that preloads content of web pages may retrieve content associated with links on the web page in the background, invisible to the user. The web browser may store the content in a memory, such as a cache, of the web browser. When the user selects a particular link that has content that has been preloaded, the web browser may be able to quickly present the content to the user.

On a web page with a small number of links, a web browser may preload the content of the web pages associated with all links. Thus, when a user clicks on one of the links, the content of the web page may load quicker than if the web browser had not preloaded the web page.

However, on a web page with a large number of links, preloading the content of the web pages associated with all links may be undesirable. Preloading content for a large number of links may take a longer amount of time than if the user were to select a link and retrieve the desired content without pre-loading.

Further, preloading content increases the amount of data transmitted and received by a computing device. Some network carriers impose limits on the amount of data that can be transmitted and received in a given time period, such as a month. A user may not be able to use the benefits of preloading content without exceeding a such a data transfer limit.

Thus, in one embodiment, one or more predicted links on a web page containing multiple links are identified. The predicted link or links may be links that the user is likely to click on. A web browser may then retrieve the content of the predicted links that the user is likely to select to present the content quickly to the user.

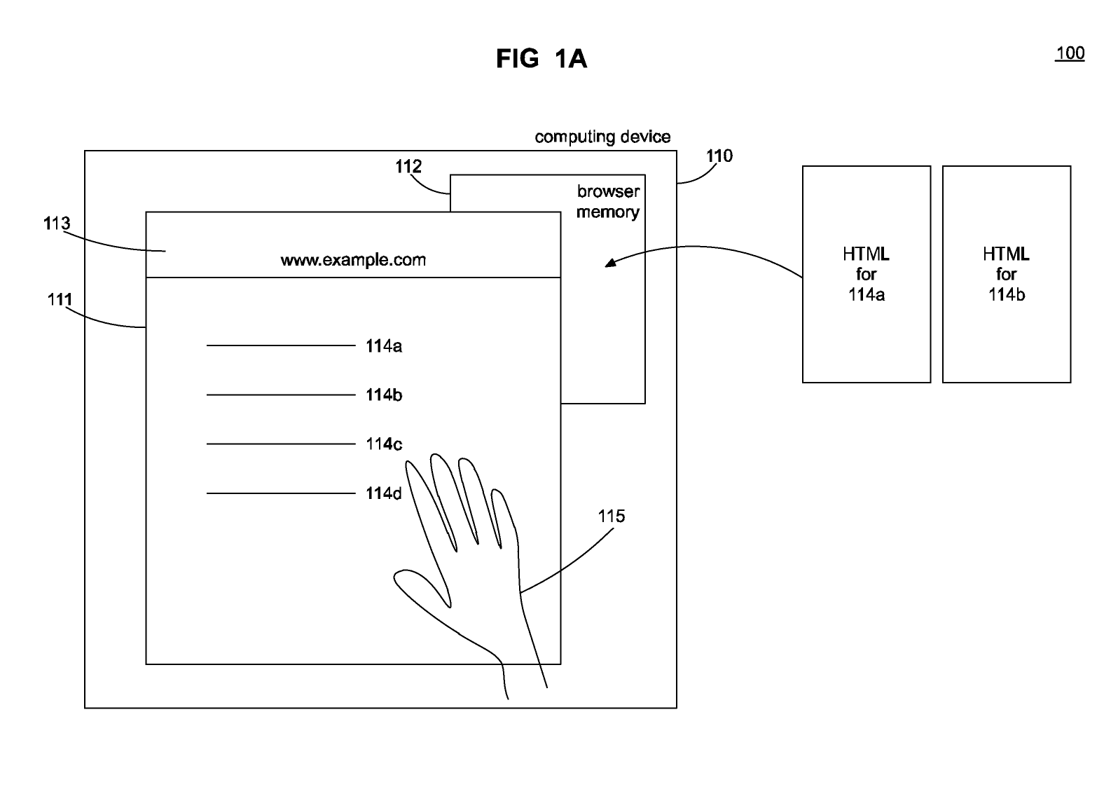

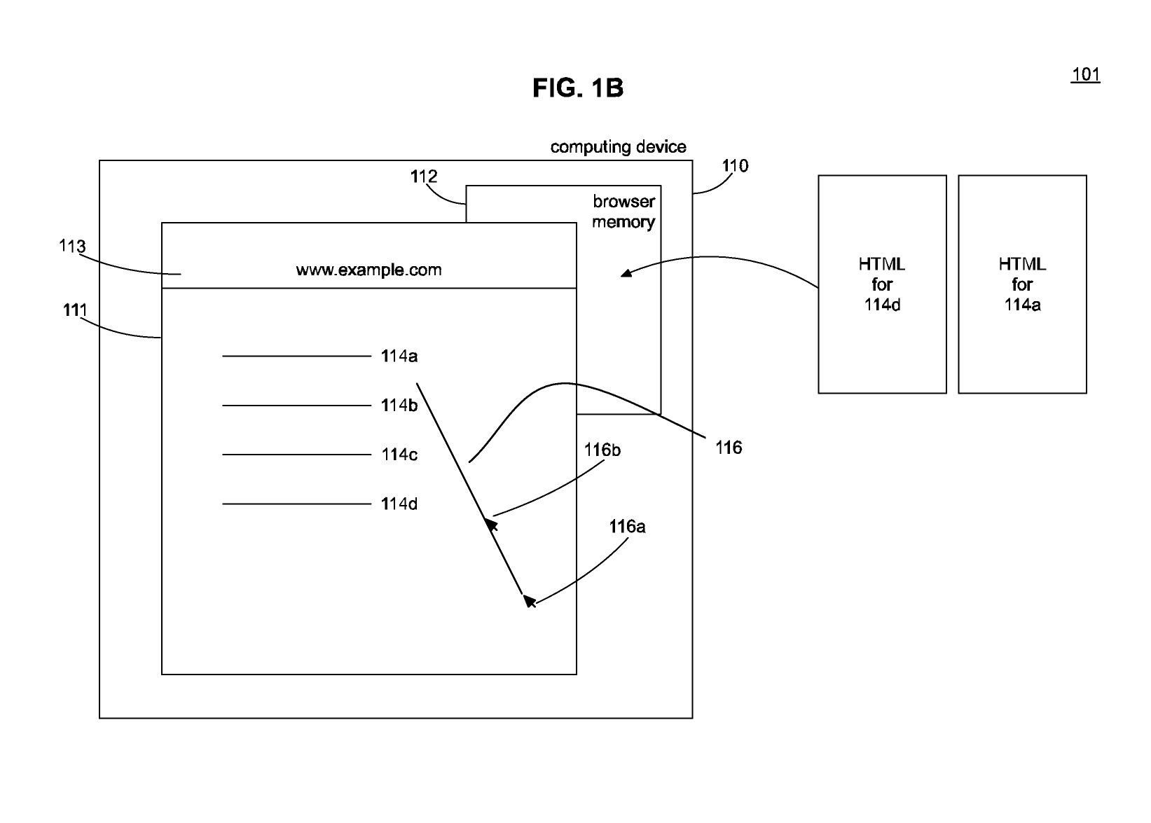

FIG. 1A is a diagram of an example pre-loading scenario 100 in accordance with an embodiment. FIG. 1A includes computing device 110, which may be a desktop computer, laptop computer, tablet computer, mobile device, smartphone, or other computing device. In scenario 100, computing device 110 may include a touch sensitive input device, such as a touch sensitive display. In scenario 100, computing device 110 is executing a web browser application 111. Web browser application 111 may have an associated browser memory 112, such as a cache memory, that may be used to temporarily store information such as previously visited web page content.

In scenario 100, web browser 111 is currently displaying a web page 113 located at www.example.com. Web page 113 contains four links, link 114a through link 114d. As computing device 110 accepts touch input via a touch sensitive input device, a user may user a finger of her hand 115 to select a link on web page 113. In accordance with an embodiment, the user's hand may be identified as moving through the air towards links 114a and 114b. The user's hand may be identified as moving towards links 114a and 114b by a camera of computing device 110, or by another method of tracking the user's hand or finger. Thus, link 114a and link 114b may be identified as predicted links, or links that the user is likely to select. Content of web pages associated with predicted links 114a and 114b may be preloaded into browser memory 111. In accordance with another embodiment, link 114a and link 114b may be identified as predicted links on other criteria as is described herein. Thus, the HTML or other content of link 114a and link 114b may be preloaded into browser memory 111. If the user selects either link 114a or link 114b, the content of the web page associated with link 114a or link 114b may be presented quickly to the user, as the content has been preloaded into browser memory 111.

FIG. 1B is a diagram of another scenario 101 in accordance with an embodiment. FIG. 1B also includes computing device 110, which is executing web browser application 111 having associated memory 112.

In scenario 101, web browser 111 is also displaying web page 113 located at www.example.com. As above, web page 113 contains four links, link 114a through link 114d. In scenario 101, computing device 110 may be a laptop computer or desktop computer which uses a mouse or trackpad to accept user input for navigating through the computer's user interface. For example, mouse pointer 116 may be used to select links displayed on web page 113. The user may initially have her mouse pointer at position 116a.

In accordance with one embodiment, the distance between the mouse pointer position 116a and the links displayed on web page 113 may be used to determine a predicted link. Thus, for example, as link 114d is closest in distance to mouse pointer position 116a, HTML content associated with link 114d may be preloaded into the memory 112 of the browser.

In accordance with another embodiment, in scenario 101, the user may be moving mouse pointer 116 from position 116a to position 116b. In accordance with an embodiment, the movement of mouse pointer 116 may be used to identify one or more predicted links on web page 113. For example, the predicted movement of mouse pointer 116, as denoted by dashed line 117, may identify link 114a as a predicted link. In response, HTML content for a web page associated with link 114a may be preloaded into memory 111 of the web browser 112. Thus, if the user actually selects link 114a, the content for the web page associated with link 114a may be presented quickly to the user, as some portion of the content is already preloaded into memory 111 of web browser 112.

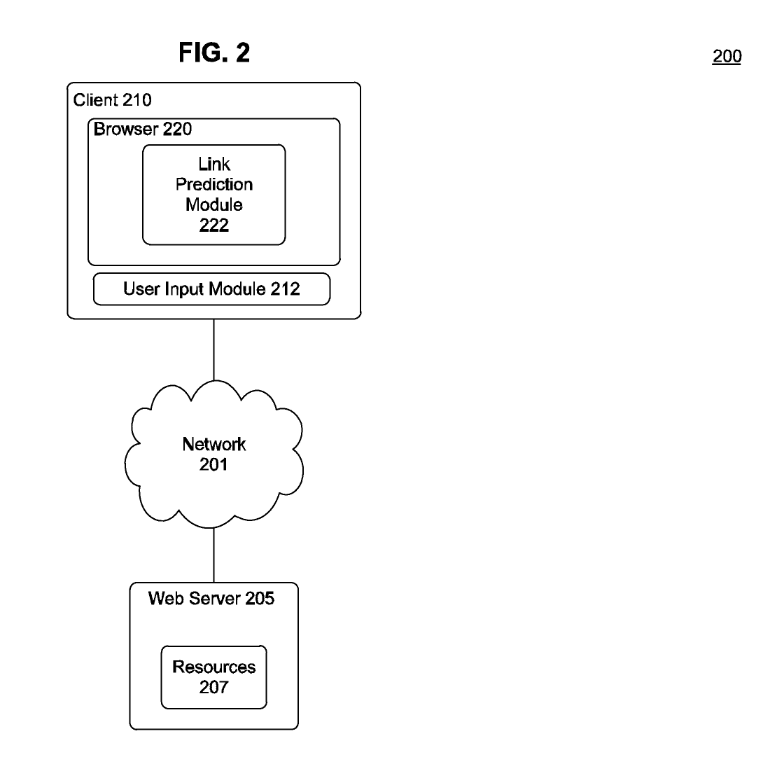

FIG. 2 is a diagram of an environment 200 in accordance with an embodiment. System 200 includes client 210. Client 210 may be a desktop computer, laptop computer, mobile device, smartphone, tablet device, or any other computing device. Client 210 may execute applications including browser 220. Client 210 further includes user input module 212. User input module 212 may accept user input from a touch sensitive input device, keyboard, mouse, or any other type of user input. Browser 220 includes link prediction module 222, which may identify a predicted link on a web page retrieved by browser 220 in accordance with an embodiment.

Environment 200 also includes web server 205, which may provide access to one or more resources 207. A resource 207 is any data that can be provided over a network, and may include, for example and without limitation, one or more web pages, HTML documents, multimedia content, images, or other resources. A resource 207 is identified by a resource address that is associated with the resource 207. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as JavaScript scripts).

A client 210 can request resources 207 from a web server 205. In turn, data representing the resource 207 can be provided to the client 210 for presentation by the client 210. Client 210 may access web server 205 using network 201, which may be a local area network or wide area network such as the Internet. The links between client 210 and network 201, and between network 201 and web server 205 may be wired links or wireless links.

In accordance with an embodiment, browser 220 of client 210 may retrieve a resource 207, such as a user-desired web page, from a web server 205 over network 201. Link prediction module 222 of browser 220 may determine one or more predicted links on the retrieved web page. Link prediction module 222 of browser 220 may determine one or more predicted links on the retrieved web page based on information received from user input module 212. Based on the predicted link or links, browser 220 may preload content of web pages associated with the predicted links by retrieving the content of the web pages from web server 205 over network 201.

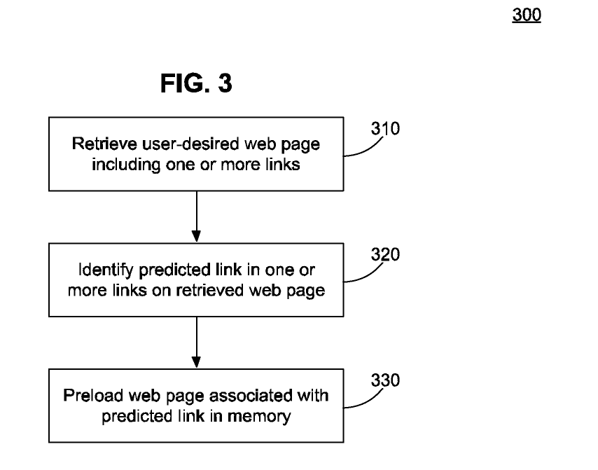

FIG. 3 is a flow chart of a method 300 for pre-loading content of a web page associated with a predicted link, in accordance with an embodiment. Method 300 may be implemented, for example and without limitation, by a web browser executing on a computing device.

Method 300 begins at stage 310. At stage 310, a user-desired web page is retrieved by a web browser. The user-desired web page may be retrieved in response to a user typing in a URL, selecting a bookmark, or selecting a link on another web page. The user-desired web page retrieved by the web browser includes one or more links.

At stage 320, a predicted link in the one or more links on the retrieved web page is identified. The predicted link may be identified based on a likelihood that the link will be selected by the user of the web browser. Examples of how predicted links are identified are explained further below. In one embodiment, multiple predicted links may be identified. In one embodiment, if a predicted link cannot be identified, a small portion of all links on the web page may be preloaded to enhance user experience.

At stage 330, a web page associated with the predicted link is preloaded. For example, the content of the web page may be preloaded into a memory of the web browser. In one embodiment, the HTML content of the web page may be preloaded into a memory of the web browser. In a further embodiment, once the HTML content is preloaded, the HTML content may be parsed and interpreted by the web browser to identify multimedia content, such as images, that can be preloaded as well.

In one embodiment, the likelihood that a predicted link will be selected may be based on a proximity metric. For example, a proximity metric may identify the distance between the user's mouse pointer or cursor and the one or more links on the web page. In one embodiment, the link that is closest to the mouse pointer, as determined by the proximity metric, may be the most likely link the user will select. Thus, the closest link may be identified as a predicted link, and content associated with the predicted link may be pre-loaded. In another embodiment, the closest “n” links may be identified as likely to be selected by the user and thus predicted links, where n can be determined by the web browser or controlled by the user. In one embodiment, the distance between the mouse cursor and a particular link may be determined as the Euclidean distance between the cursor and the link. The link with the shortest Euclidean distance may be identified as having the highest likelihood of being selected by the user, and may be identified as the predicted link.

In another embodiment, a velocity approximation of a gesture trajectory may be used to identify a predicted link. When a user moves his or her mouse pointer towards a link on a web page, the velocity of the mouse pointer typically decreases as the user approaches the desired link. In one embodiment, the predicted link may be identified based on deceleration of the mouse pointer. For example, in one embodiment, a web browser may use the rate of deceleration to identify the most likely link that the user's mouse pointer will select, identify that link as the predicted link, and preload the web page associated with the predicted link. In a further embodiment, the web browser may identify a number of links that are likely to be selected based on the rate of deceleration, identify those links as the predicted links, and preload content associated with those predicted links. In yet a further embodiment, the web browser may use probabilistic models to determine in which order the content of the predicted links should be preloaded.

In one embodiment, the web browser may use statistics related to the web pages associated with the links to identify a predicted link. For example, on a news page with a large number of links to news articles, a web browser may have access to statistics that identify how many users clicked on a particular news article link. Similarly, a web browser may have access to anonymized statistics that identify what percentage of users have clicked on a given link. Such statistics may be used as a popularity score for each link. In one embodiment, the link with the highest popularity score may be identified as a predicted link, and a web page associated with the predicted link may be preloaded by the web browser.

In one embodiment, a predicted link may be identified based in part on machine learning techniques. For example, a web browser executing on a user's computer may provide the user with the option to collect statistics about the user's browsing history to improve the user's experience. For example, machine learning techniques may identify that the user of the web browser frequently clicks on links with certain words in the title. In the example of restaurant websites given above, machine learning techniques may identify that a user of a web browser frequently clicks on links named “Menu” or links that lead to similar web pages. Thus, if the user is on a web page with a link named “menu”, the web browser may identify that link as a predicted link, and pre-load the content of the web page associated with the link. Similarly, machine learning techniques may identify that the user is interested in a particular sports team, a particular musical act, or other subjects, and identify links associated with those identified subjects as predicted links.

In one embodiment, higher level models may be used to identify predicted links. For example, models based on Bezier curves, Kalman filter, or constant velocity models may be used to predict which link the user is likely to click on. Further, machine learning techniques may be used to identify user-specific gesture patterns, and predict which link or links the user is likely to click on based on a determined gesture pattern.

Some embodiments may be used on mobile devices, such as smartphones, and tablet devices. Such devices may not use a conventional mouse pointer, and may instead have a touch-sensitive interface. Such devices are often equipped with a camera. Thus, in one embodiment, the camera of a mobile device may be configured to track the movement of a finger of the user of the mobile device in three-dimensional space to identify a predicted link that the user is likely to click on. For example, the camera may track the position of the user's finger relative to the screen as it moves on the screen, and identify a predicted link based on the position of the user's finger when the user's finger stops moving or approaches the screen to select a desired link. In a further embodiment, the camera of a mobile device or other device may be configured to track the movement of the user's eyes to determine a link the user is looking at, and identify that link as a predicted link that the user is likely to click on.

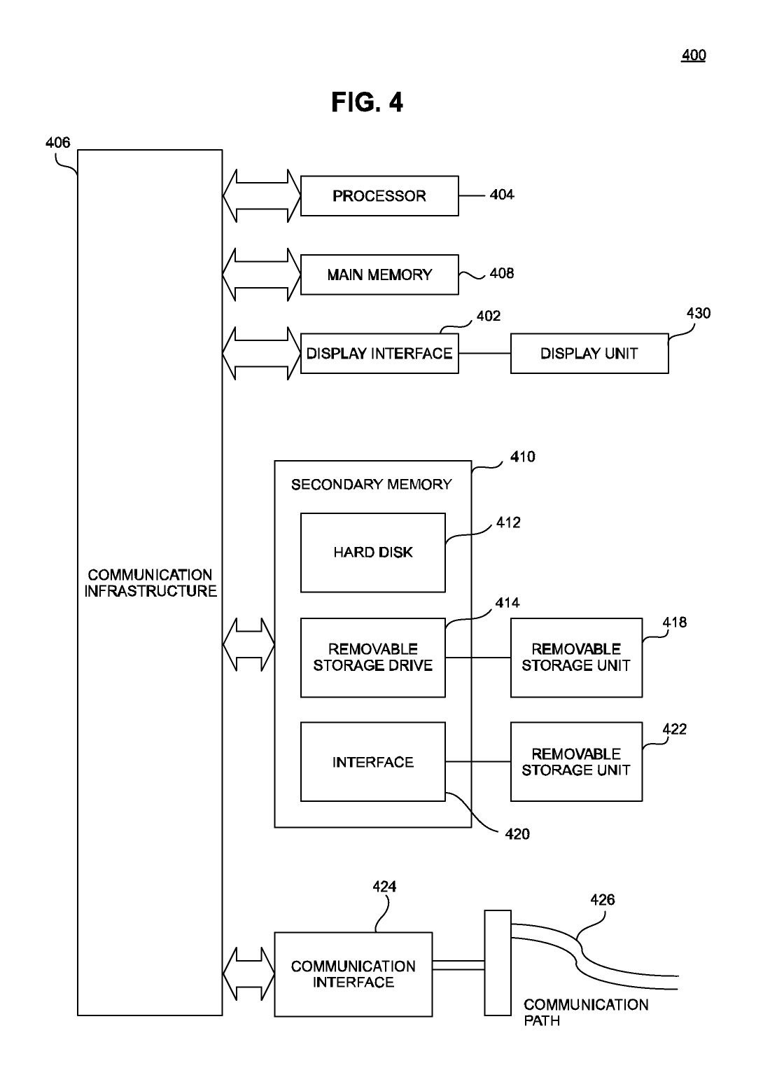

Various aspects of the present invention can be implemented by software, firmware, hardware, or a combination thereof. FIG. 4 illustrates an example computer system 400 in which the embodiments, or portions thereof, can be implemented as computer-readable code. For example, browser 220 carrying out method 300 of FIG. 3 can be implemented in system 400. Various embodiments of the invention are described in terms of this example computer system 400.

Computer system 400 includes one or more processors, such as processor 404. Processor can be a special purpose or a general purpose processor. Processor 404 is connected to a communication infrastructure 406 (for example, a bus or network).

Computer system 400 also includes a main memory 408, preferably random access memory (RAM), and may also include a secondary memory 410. Secondary memory 410 may include, for example, a hard disk drive and/or a removable storage drive. Removable storage drive 414 may include a floppy disk drive, a magnetic tape drive, an optical disk drive, a flash memory, or the like. The removable storage drive 414 reads from and/or writes to removable storage unit 418 in a well-known manner. Removable storage unit 418 may include a floppy disk, magnetic tape, optical disk, etc. which is read by and written to by removable storage drive 414. As will be appreciated by persons skilled in the relevant art(s), removable storage unit 418 includes a computer usable storage medium having stored therein computer software and/or data.

In alternative implementations, secondary memory 410 may include other similar means for allowing computer programs or other instructions to be loaded into computer system 400. Such means may include, for example, a removable storage unit 422 and an interface 420. Examples of such means may include a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to computer system 400.

Computer system 400 may also include a communications interface 424. Communications interface 424 allows software and data to be transferred between computer system 400 and external devices. Communications interface 424 may include a modem, a network interface (such as an Ethernet card), a communications port, a PCMCIA slot and card, or the like. Software and data transferred via communications interface 424 are in the form of signals which may be electronic, electromagnetic, optical, or other signals capable of being received by communications interface 424. These signals are provided to communications interface 424 via a communications path 426. Communications path 426 carries signals and may be implemented using wire or cable, fiber optics, a phone line, a cellular phone link, an RF link or other communications channels.

In this document, the term “computer readable storage medium” is used to generally refer to media such as removable storage unit 418, removable storage unit 422, and a hard disk installed in hard disk drive 412. Computer readable storage medium can also refer to one or more memories, such as main memory 408 and secondary memory 410, which can be memory semiconductors (e.g. DRAMs, etc.). These computer program products are means for providing software to computer system 400.

Computer programs (also called computer control logic) are stored in main memory 408 and/or secondary memory 410. Computer programs may also be received via communications interface 424. Such computer programs, when executed, enable computer system 400 to implement the embodiments as discussed herein. In particular, the computer programs, when executed, enable processor 404 to implement the processes of embodiments of the present invention, such as the steps in the methods discussed above. Accordingly, such computer programs represent controllers of the computer system 400. Where embodiments are implemented using software, the software may be stored in a computer program product and loaded into computer system 400 using removable storage drive 414, interface 420, or hard drive 412.

Embodiments of the invention also may be directed to computer program products comprising software stored on any computer-readable medium. Such software, when executed in one or more data processing device, causes a data processing device(s) to operate as described herein. Embodiments of the invention employ any computer useable or readable medium. Examples of tangible computer-readable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

Embodiments may be implemented in hardware, software, firmware, or a combination thereof. Embodiments may be implemented via a set of programs running in parallel on multiple machines.

The summary and abstract sections may set forth one or more but not all exemplary embodiments of the present invention as contemplated by the inventor(s), and thus, are not intended to limit the present invention and the appended claims in any way.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A computer-implemented method comprising:
retrieving a user-desired web page by a web browser, wherein the user-desired web page contains one or more links;
identifying a predicted link in the one or more links on the user-desired web page, wherein the predicted link is based on a likelihood that the predicted link will be selected by a user of the web browser, the likelihood being determined using a proximity metric to determine the predicted link in the one or more links on the user-desired webpage that is likely to be selected by the user of the web browser, wherein the proximity metric is a velocity approximation of a gesture trajectory;
identifying a popularity score associated with the one or more links on the user-desired webpage; and
preloading a webpage associated with the predicted link in a memory of the web browser.

2. The method of claim 1, wherein the predicted link is further based on the popularity score of each of the one or more links.

3. The method of claim 1, wherein preloading the webpage associated with the predicted link in the memory of the web browser further comprises:
preloading HTML content and images of the webpage associated with the predicted link into the memory of the web browser.

4. A system comprising:
one or more computers and one or more storage devices storing instructions that are operable, when executed by the one or more computers, to cause the one or more computers to perform operations comprising:
retrieving a user-desired web page by a web browser, wherein the user-desired web page contains one or more links;
identifying a predicted link in the one or more links on the user desired web page, wherein the predicted link is identified based on a likelihood that the predicted link will be selected by a user of the web browser the likelihood being determined using a proximity metric to determine the predicted link in the one or more links on the user-desired webpage that is likely to be selected by the user of the web browser, wherein the proximity metric is a velocity approximation of a gesture trajectory;
identifying a popularity score associated with one or more links on the user-desired webpage; and
preloading a webpage associated with the predicted link in a memory of the web browser.

5. The system of claim 4, wherein the predicted link is further based on the popularity score of each of the one or more links.

6. The system of claim 4, wherein preloading the webpage associated with the predicted link in the memory of the web browser further comprises:
preloading HTML content and images of the webpage associated with the predicted link into the memory of the web browser.

7. A non-transitory computer-readable medium storing software comprising instructions executable by one or more computers which, upon such execution, cause the one or more computers to perform operations comprising:
retrieving a user-desired web page by a web browser, wherein the user-desired web page contains one or more links;
without a user selecting a link from the one or more links, identifying a predicted link in the one or more links on the user-desired web page, wherein the predicted link is based on a likelihood that the predicted link will be selected by a user of the web browser, the likelihood being determined using a proximity metric to determine the predicted link in the one or more links on the user-desired webpage that is likely to be selected by the user of the web browser, wherein the proximity metric is a velocity approximation of a gesture trajectory;
identifying a popularity score associated with the one or more links on the user-desired webpage; and
preloading a webpage associated with the predicted link in a memory of the web browser.

8. The non-transitory computer-readable medium of claim 7, wherein the predicted link is further based on the popularity score of each of the one or more links.

9. The non-transitory computer-readable medium of claim 7, wherein preloading the webpage associated with the predicted link in the memory of the web browser further comprises:
preloading HTML content and images of the webpage associated with the predicted link into the memory of the web browser.

10. A system, comprising:
a processor;
a memory; and
a web browser, implemented on the processor, configured to:
retrieve a user-desired web page, wherein the user-desired web page contains one or more links;
identify a predicted link in the one or more links on the user desired web page, wherein the predicted link is identified based on a likelihood that the predicted link will be selected by a user of the web browser, the likelihood being determined using a proximity metric to determine the predicted link in the one or more links on the user-desired webpage that is likely to be selected by the user of the web browser, wherein the proximity metric is a velocity approximation of a gesture trajectory;
identify a popularity score associated with the one or more links on the user-desired webpage; and
preload a webpage associated with the predicted link in the memory.
